(19) United States
(12) Patent Application Publication
(10) Pub. No.: US 2015/0013558 A1
(43) Pub. Date: Jan. 15, 2015

(54) TREATMENT OF PRINTS FOR IMPROVING OVERCOAT INTEGRITY

(71) Applicant: XEROX CORPORATION, NORWALK, CT (US)

(72) Inventors: NAVEEN CHOPRA, OAKVILLE (CA); GORDON SISLER, ST. CATHERINES (CA); BIBY ABRAHAM, MISSISSAUGA (CA); GAIL SONG, MILTON (CA)

(21) Appl. No.: 13/942,666

(22) Filed: Jul. 15, 2013

(51) Int. Cl. B41F 23/00

(52) U.S. Cl. CPC B41F 23/002
USPC 101/425; 101/483

(57) ABSTRACT

A printing system including an oil removal sub-system having an application device impregnated with an oil removal solution including a low carbon alcohol. The application device is operable downstream of a spreader of the printing system. The application device is adapted to contact a printed media after it contacts the spreader. The printing system results in oil-free prints suitable for subsequent finishing operations, in-line or off-line, such as overprint coating, lamination, and adhesive binding.

### TECHNICAL FIELD

This disclosure is generally directed to systems and methods for forming robust prints. More specifically, this disclosure is directed to a system and method thereof that removes residual oils from freshly printed images produced by direct-to-paper printing.

### BACKGROUND

Current printing systems use solid ink and utilize a continuous-web direct-to-paper print architecture, such as CiPress® by Xerox Corporation. During the continuous-web direct-to-paper process, ink is jetted onto the web. Thereafter, a high pressure roller nip, also referred to as a spreader, spreads the ink on the web to achieve the desired print image. In turn, silicone oil from the spreader is left on the ink.

After exiting the spreader, an aqueous overcoat is applied to the freshly printed image to ensure image robustness. The overcoat protects the ink of the printed image from being rubbed off or scratched off the surface of the media substrate (e.g., paper).

There is a challenge when overcoating freshly printed ink in the continuous-web direct-to-paper print architecture. Due to the low surface energy of the ink and the residual oil from the spreader that remains on the surface of the media substrate having the freshly printed ink, images with crease areas (white space) are produced.

There remains a need for a system and method that removes, prior to the overcoating step, residual oil from the surface of the media substrate having freshly printed ink.

### SUMMARY

The following detailed description is of the best currently contemplated modes of carrying out exemplary embodiments herein. The description is not to be taken in a limiting sense, but is made merely for the purpose of illustrating the general principles of the disclosure herein, since the scope of the disclosure herein is best defined by the appended claims.

Various inventive features are described below that can each be used independently of one another or in combination with other features.

Broadly, embodiments of the disclosure herein generally provide a printing system including an oil removal subsystem having an application device impregnated with an oil removal solution including a low carbon alcohol.

In another aspect of the disclosure herein, a system for online oil removal from printed media including an oil removal solution including a low carbon alcohol, the oil removal solution is operable downstream of a spreader of the printing system, and the oil removal solution is adapted to contact a printed media after the printed media contacts the spreader.

In yet another aspect of the disclosure herein a method for oil removal from printed media including receiving a printed media, applying to the printed media an oil removal solution containing low carbon alcohol, and removing oil removing solution from the printed media.

### BRIEF DESCRIPTION OF THE FIGURES

Various embodiments of the present disclosure will be described herein below with reference to the following figures wherein:

FIG. 1 illustrates a system according to an exemplary embodiment of the disclosure herein;

FIGS. 2A to 2C are images of printed media following oil removal according to embodiments herein, and without oil removal;

FIGS. 3A to 3F are images of the results of profilometry examination of printed media following oil removal according to embodiments herein, and without oil removal;

FIGS. 4A to 4D illustrate robustness measurements of printed media following oil removal according to embodiments herein, and without oil removal;

FIGS. 5A and 5B are graphs that show a measurement of fold crease area on coated printed medias according to embodiments herein; and

FIG. 6 is a flowchart for a method for oil removal from printed media according to the present disclosure.

### DETAILED DESCRIPTION

The present disclosure provides systems and methods that remove residual oils from freshly printed images produced by direct-to-paper printing prior to applying a protective overcoat to the printed image, thereby yielding a uniform image.

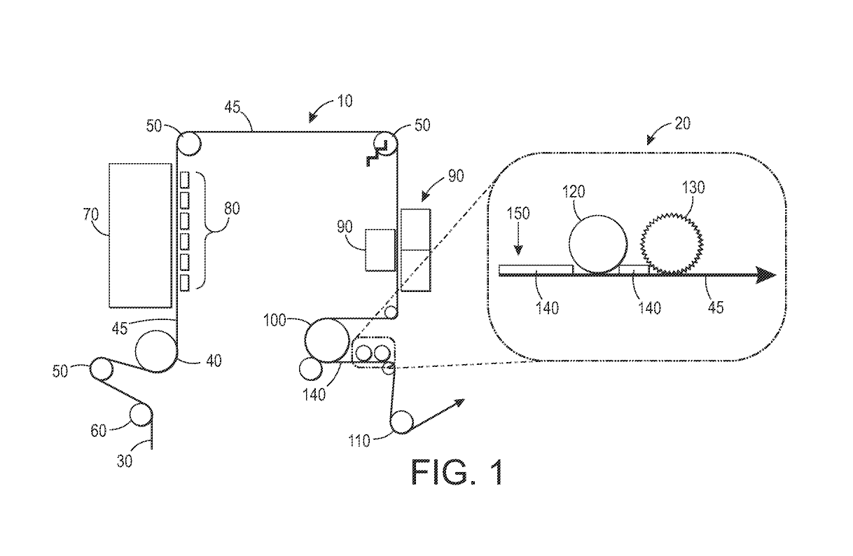

FIG. 1 illustrates a printing system 10, such as a continuous-web direct-to-paper printing system, according to an exemplary embodiment of the disclosure herein. The system 10 may include an oil removal subsystem 20.

The system 10 may supply a continuous web of media 30, for example, paper, from a media source 40, such as a spool. The continuous web of media 30 may be unwound as needed, and propelled by a variety of motors, not shown. A set of rolls 50 may control the tension of the unwinding media 30 as the media 30 moves through a path 45. Along the path 45, there may be preheater 60, which can bring the media 30 to an initial predetermined temperature. The media 30 can then move through a printing device 70 including a series of print-heads 80. Each print-head 80 may extend across the width of the media 30.

Following the printing device 70 may be one or more mid-heaters 90. The mid-heaters 90 can use contact, radiant, conductive, and/or convective heat to bring the ink on the media to a temperature suitable for desired properties when the ink on the media is sent through the spreader 100. The temperature may depend on the type of ink used on the printing device 70. The ink may be, for example, a solid ink that may include hydrocarbon wax (>50%), resin, dispersant, and pigments, such as commercial Xerox® phase-change solid inks sold under the brand names of Phaser® or ColorQube®.

The spreader 100 may include any suitable system or apparatus that applies a predetermined pressure and, in some implementations, heat to the media 30. Thus, the spreader 100 may include drums (not shown), such as an image-side drum (not shown) and pressure roll (not shown) that apply heat and pressure to the media 30. In addition, the spreader 100 may include a cleaning/oiling station (not shown) associated with the image-side drum (not shown), suitable for cleaning and/or applying a layer of a lubricant, for example, amino silicone oil.

The spreader 100 takes what are essentially droplets, strings of droplets, or lines of ink on web media 30 and smears them by pressure, with or without heat, so that spaces between adjacent droplets are filled and the image becomes uniform. The media 140 leaving the spreader 100 may contain residual oil 150 on the printed image.

An oil removal subsystem 20 may be immediately downstream of the spreader 100 and immediately upstream of a coating station 110. The coating station 110 can be configured to coat a clear ink overcoating to the printed media.

In one embodiment according to the present disclosure, the oil removal subsystem 20 may be an offline system that can include an application device that is offline of the media path 45 such as a cloth impregnated with a low carbon alcohol. In such embodiment, a user may use the low carbon alcohol impregnated cloth to contact the printed image and thereby apply the low carbon alcohol to the residual oil on the image. Upon wiping the application device on the printed image, the residual oil may be removed.

In another embodiment according to the present disclosure, the oil removal subsystem 20 may be an online system that can include an application device that is online of the media path 45 such as shown on FIG. 1. Therein, the application device can include a wetting roller 120 downstream of the spreader 100 and a wiping roller 130 located downstream of the wetting roller 120. Thus, the wetting roller 120 can contact the printed image to apply the low carbon alcohol to the image. And the wiping roller 130 can thereafter remove the residual oil.

The wetting roller 120 and/or the wiping roller 130 may be covered by a soft material, for example, cloth, fabric, or terry cloth. The wetting roller 120 can be impregnated with an oil removal solution, such as a low carbon alcohol solution. The residual oil 150 on the printed image is desirably miscible with the oil removal solution. Thereby, when the wetting roller 120 contacts the printed media, the residual oil tends to mix with the oil removal solution. Next, the media 140 passes by the wiping roller 130 to wipe off both oil removal solution and residual oil from the printed image.

The wiping material can be spread onto the printed image with a conformal sponge or cloth-type roller that is pre-wetted with a transfer roll. Immediately following this conformal roll, there can be a pick-up roll (also made of a porous material such as sponge or cloth) that can wipe the wetted print.

The oil removal solution in/on the wetting roller 120 may be a low carbon alcohol. The amount of the low carbon alcohol may be, for example, from about 5 to about 20 milliliters of low carbon alcohol per square meter of the printed media, or from about 7 to about 18 milliliters of low carbon alcohol per square meter of the printed media, or from about 10 to about 15 milliliters of low carbon alcohol per square meter of the printed media.

The specific low carbon alcohol used may depend on several factors, for example, miscibility with the residual oil, mild enough to avoid attack of the printed surface, volatile enough to evaporate so as not to compromise the overcoating step, and being non-toxic and mild which leaves no residue.

The number of carbons in the low carbon alcohol may be in embodiments from about 3 to about 8, or from about 3 to about 6, or from about 3 to about 5. If the low carbon alcohol has more than about 6 carbons, then the alcohol may have more hydrocarbon character and may tend to rub the solid ink off the printed media. In various embodiments, the low carbon alcohol may be, for example, isopropanol, 1-butanol, 2-butanols, hexyl alcohol, and 1-octanol. In one embodiment, the low carbon alcohol is, for example, isopropanol.

Table 1 shows some characteristics of exemplary low carbon alcohols according to the present disclosure

TABLE I

| Chain | | | | | Miscible in |
|---|---|---|---|---|---|
| length | Alcohol | Density/g/mL | Bp/C | RT visc/cps | oil |
| C3 | Isopropanol | 0.785 | 82 | 1.96 | Y |
| C4 | 1-butanol | 0.81 | 116 | 3 | Y |
| C4 | 2-butanol | 0.808 | 98 | 3 | Y |
| C6 | Hexyl | 0.814 | 156 | 5.4 | N |
| | alcohol | | | | |
| C8 | 1-octanol | 0.827 | 196 | 10.6 | N |

The amount of low carbon alcohol solution applied to the printed image can vary according to the amount of residual oil on the printed image. In other words, a greater amount of low carbon alcohol solution can be used for a greater amount of residual oil. However, this quantitative relationship is only general in nature.

The media 40 on which the printed image is located can be of varying types, such as uncoated paper, coated paper, or plastic film, for example, a polyester film made of polyethylene terephthalate (PET) such as Mylar® sold by DuPont, a biaxially oriented polypropylene (BOPP) film sold by Innovia, or aluminum foil. The specific media 40 used can vary inasmuch as it does not contact the low carbon alcohol solution according to some embodiments. Thus, there can be little, if any, contact between the low carbon alcohol solution and the media 40, which tends to minimize concern about potential adverse effects due to such contact.

### EXAMPLE

The following Example illustrates one exemplary embodiment of the present disclosure. This Example is intended to be illustrative only to show one of several methods of removing oil from a printed media and is not intended to limit the scope of the present disclosure. Also, parts and percentages are by volume unless otherwise indicated.

Coating Method “A”—Meyer rod coating method

Solid ink prints were generated using a drum maintenance unit (DMU) that contains spreader oil, in lieu of the usual transfix oil used in a typical office printer mode. After printing the solid fills, a KimWipe® by Kimberly-Clark was moistened with isopropanol alcohol (IPA) and the print was rubbed in a gentle sweeping motion. Next, the treated print was coated with a Mathis Labcoater using a #2 ½ Meyer rod (wire-wound rod) and heated to 80° C. for 2 minutes with a series of coating formulations (see Table II).

Coating Method “B”—K-proof coating of overcoat (simulation of Interflex in-line coater/tinter process)

Solid ink prints (as described in method A) were cut to 5×8.5 inch rectangles, and subjected to coating with the overcoat solutions as indicated on Table II.

TABLE II

| Coating | Description | Coating method used |
|---|---|---|
| Sun 419 ® | Commercial coating (Sun Chemical) | A, B |
| 125B | In-house coating comprising ammonium | A |
| | salt of modified acrylic copolymers with | |
| | low Tg (−16° C.) acrylic latex and | |
| | polyethylene wax emulsion. | |
| Protec ® | Commercial coating (Actega) | B |

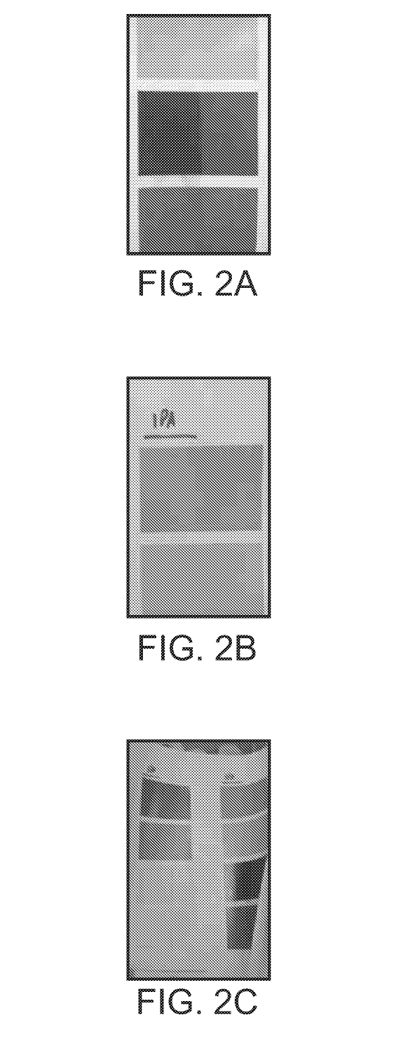

FIGS. 2A-2C illustrate images of the printed media wiped with the low carbon alcohol (left side of each print) and printed media unwiped with the low carbon alcohol (right side of each print) and then coated according to the Method A. FIG. 2A shows three printed media having the left side wiped with the low carbon alcohol while the right side was not wiped with the low carbon alcohol prior to the coating step. FIG. 2B shows two printed media, with the left side wiped with the low carbon alcohol while the right side was not wiped with the low carbon alcohol prior to the coating step. FIG. 2C show eight printed media with the left side wiped with the low carbon alcohol while the right side was not wiped with the low carbon alcohol prior to the coating step. As can be seen from FIGS. 2A-2C, there is dramatic difference in coating integrity after wiping the printed media with the low carbon alcohol and not wiping the printed media with the low carbon alcohol. The area wiped with the low carbon alcohol shows glossy, uniform coatings, with no ‘beading-up’ of the overcoat.

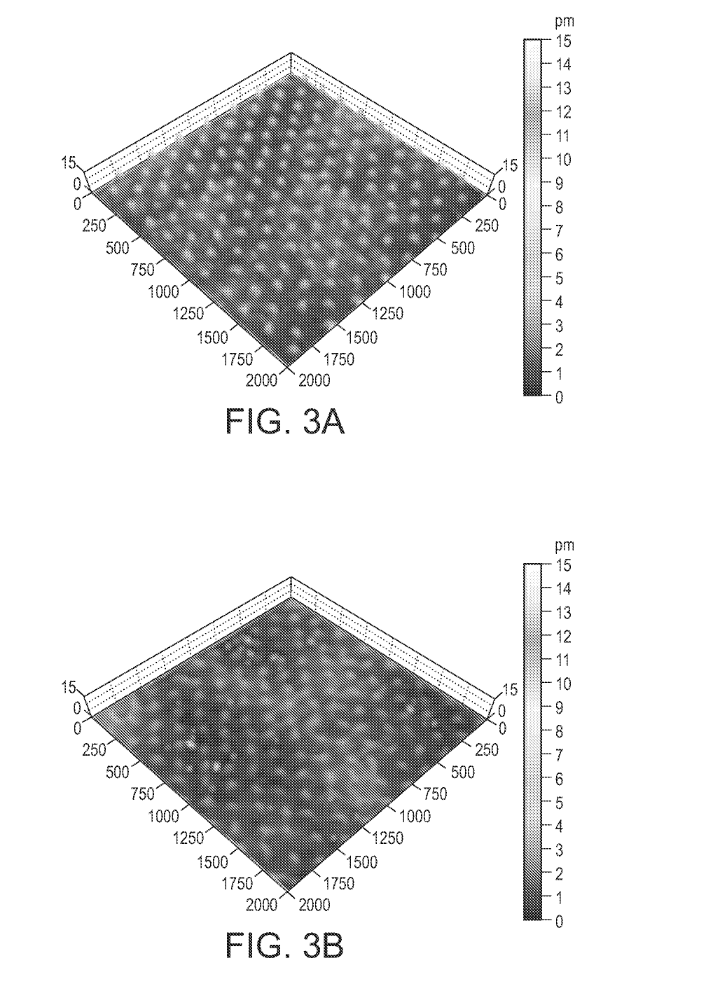

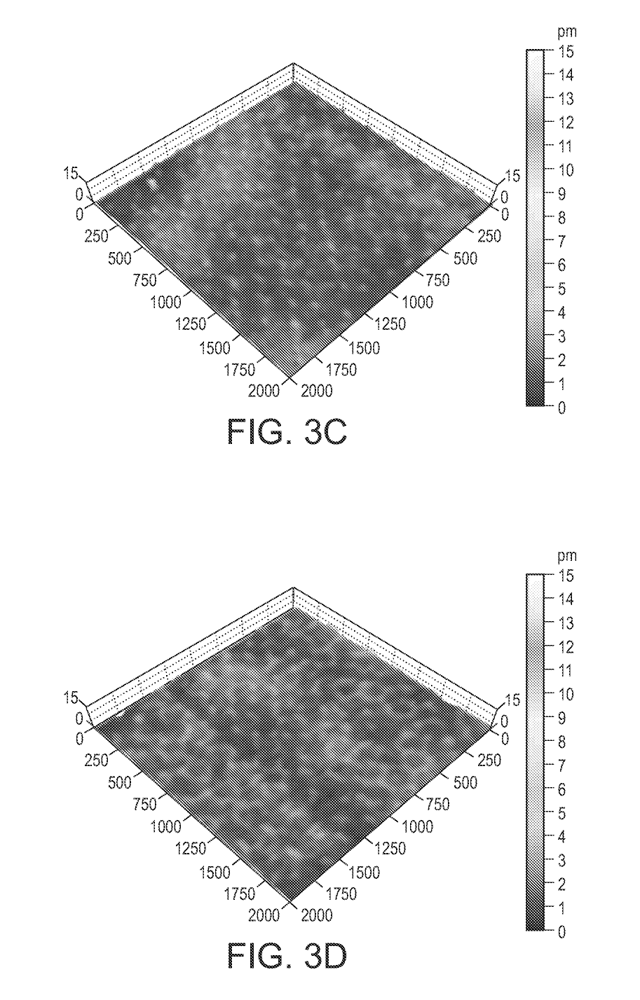

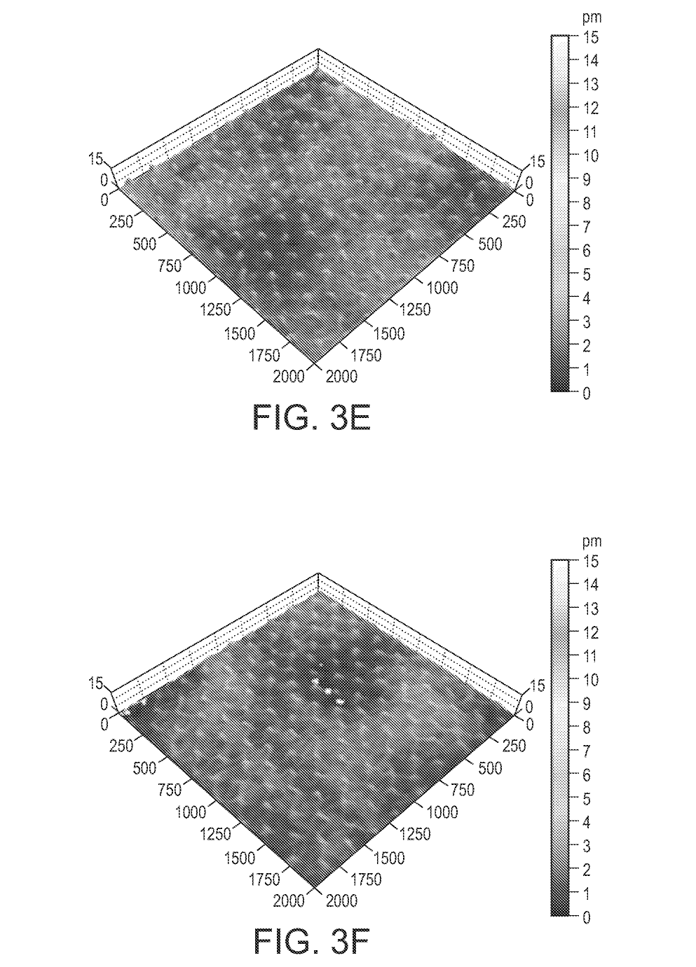

FIGS. 3A-3F illustrate images of the results of a profilometry exam based on the printed media wiped with the low carbon alcohol (right side of each print) and printed media unwiped with the low carbon alcohol (left side of each print) and then coated according to the Method B. FIG. 3A shows images of the results of a profilometry exam of a printed media that was not rubbed with the low carbon alcohol solution. FIG. 3C shows the printed media of FIG. 3A after coating the printed media with SUN 419® by Sun Chemical and air dried. FIG. 3B shows images of the results of a profilometry exam of a printed media that was rubbed with the low carbon alcohol solution. FIG. 3D shows the printed media of FIG. 3B after coating the printed media with SUN 419® and air dried. FIG. 3D shows images of the results of a profilometry exam of a printed media that was not rubbed with the low carbon alcohol solution and then coated with 125-B by Xerox Corporation. FIG. 3F shows a printed media that was rubbed with the low carbon alcohol solution and then coated with 125-B and air dried. It can be seen from FIGS. 3A-3F that there is dramatic difference in the presence of residual oil after wiping the printed media with the low carbon alcohol and not wiping the printed media with the low carbon alcohol. The area wiped with the low carbon alcohol shows a very low presence of residual oil and the area unwiped with the low carbon uniform shows presence of the recovery oil.

Robustness Measurements

Crease fold measurements were done to test the effectiveness of the coating in improving robustness—the more ink flaked off, the worse the coating integrity.

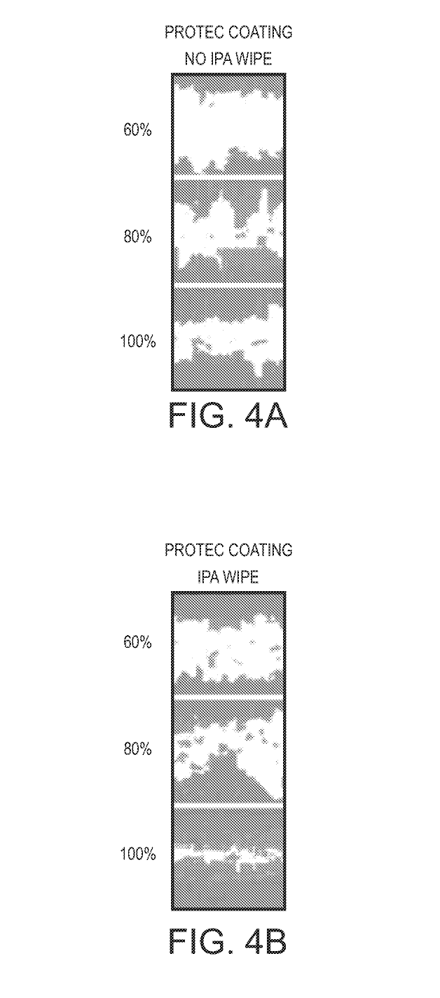

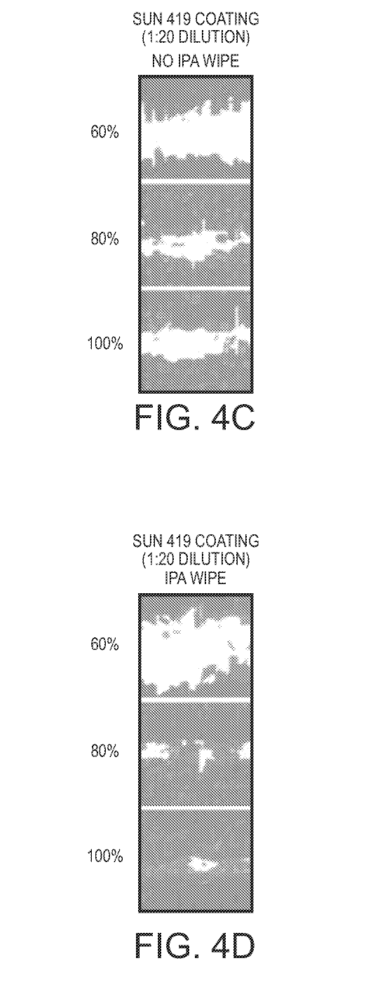

FIGS. 4A-4B illustrate the results of the robustness measurements based on the printed media wiped with the low carbon alcohol (right side of each print) and printed media unwiped with the low carbon alcohol (left side of each print). FIG. 4A shows the robustness measurements for printed media that were not wiped with the low carbon alcohol solution and then coated with Protec® by Actega protective coating. FIG. 4B shows the robustness measurements for printed media that were wiped with different dilutions of the low carbon alcohol solution and then coated with Protec® coating. FIG. 4C shows the robustness measurements for printed media that were not wiped with different dilutions of the low carbon alcohol solution and then coated with Sun 419®. FIG. 4D shows the robustness measurements for printed media that were wiped with different dilutions of the low carbon alcohol solution and then coated with Protec® protective coating. As can be seen from FIGS. 4A-4D, there is dramatic difference in the presence of crease area (white space) after wiping the printed media with the low carbon alcohol and not wiping the printed media with the low carbon alcohol.

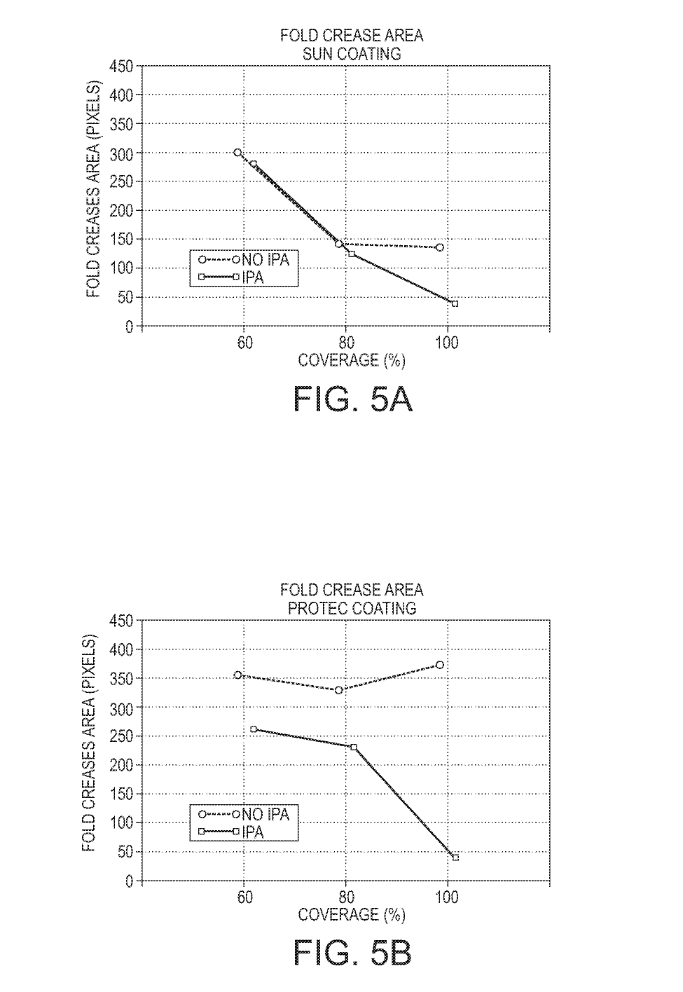

FIGS. 5A and 5B are graphs that show a measurement of fold crease area on coated printed media according to embodiments herein. FIG. 5A shows a graph showing the plotting of fold crease area vs. % area coverage of the coating for the printed images of FIGS. 4A and 4B (the Protec® coating without alcohol wiping of the print and the Protec® coating with alcohol wiping of the print, respectively). FIG. 5B shows a graph showing the plotting of fold crease area vs. % area coverage of the coating for the printed images of FIGS. 4C and 4D (the Sun419® coating without alcohol wiping of the print and the Sun419® coating with alcohol wiping of the print, respectively). In both Figures, the dashed lines represent the prints that were not wiped with alcohol, and the solid lines represent the prints that were wiped with alcohol. In the graphs, the y-axis represents the area (pixels) removed by fold-crease (white area). The x-axis represents the amount of solid area coverage of the coating. As can be seen from the graph, there is a significant reduction in y-axis value for both the Protec® and Sun419® coatings at high % area coverage.

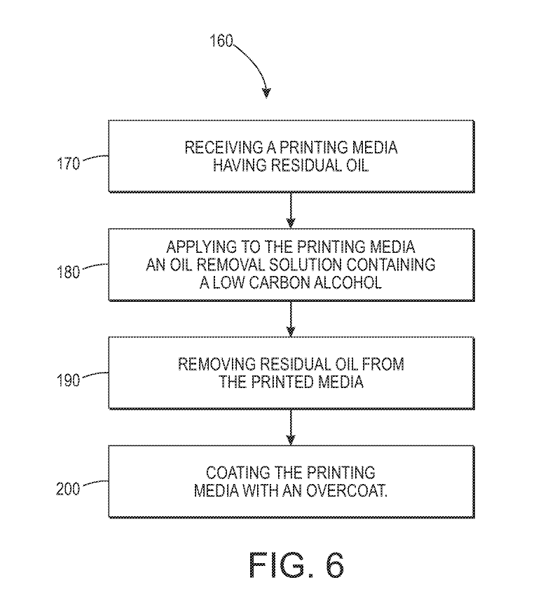

As shown in FIG. 6, the present disclosure also relates to a method 160 for oil removal from and overcoating of a printed image. A step 170 can include receiving a printed media having residual oil, such as from a spreader. A step 180 may include applying to the printed media an oil removal solution that can include a low carbon alcohol, such as by contacting the printed media with an application device. The step 180 can be either online or offline of a path of the printed media in a printing system. A step 190 may include removing residual oil removal solution from the printed media, such as by wiping the printed media with the application device. A step 200 may include coating the printed media with an overcoat.

It will be appreciated that variations of the above-disclosed and other features and functions, or alternatives thereof, may be desirably combined into many other different systems or applications. Also that various, presently unforeseen or unanticipated alternatives, modifications, variations or improvements therein may be subsequently made by those skilled in the art which are also intended to be encompassed by the following claims.

1. A direct-to-paper printing system, comprising:
an oil removal subsystem having an application device impregnated with an oil removal solution including isopropanol;
wherein the oil removal subsystem removes residual oils from a printed image having no protective overcoat;
a coating station downstream of the oil removal subsystem for applying a protective overcoat to a printed image;
wherein, when the printed image has a protective overcoat at about 100% coverage of the printed image, the subsystem reduces a fold crease area of the printed image with a protective overcoat by a factor of about 7 in comparison to a printed image with a protective overcoat without oil removal.

2. The printing system according to claim 1, wherein the application device comprises a cloth.

3. The printing system according to claim 1, wherein the application device comprises a wetting roller.

4. The printing system according to claim 3, wherein the application device further includes a wiping roller downstream of the wetting roller.

5. The printing system according to claim 4, wherein the wetting roller and the wiping roller are covered by a material selected from cloth, fabric, and terry cloth.

6. (canceled)

7. (canceled)

8. A printing system for online oil removal from printed media, comprising:
a spreader for applying an oil on the printed media;
an oil removal subsystem including a low carbon alcohol;
wherein the oil removal subsystem is operable downstream of the spreader;
wherein the oil removal subsystem is adapted to wipe a printed media after the spreader applies oil on the printed media;
wherein a wiped printed media has a fold crease area of about 50 pixels.

9. The system according to claim 8, wherein the oil removal subsystem further includes:
an application device having
a wetting roller and a wiping roller downstream of the wetting roller.

10. The system according to claim 8, further including a coating station downstream of the oil removal solution.

11. The system according to claim 9, wherein the wetting roller and the wiping roller are covered by a material selected from cloth, fabric, and terry cloth.

12. The system according to claim 8, wherein the low carbon alcohol is selected from the group consisting of isopropanol, 1-butanol, 2-butanols, hexyl alcohol, and 1-octanol.

13. (canceled)

14. A method for oil removal from printed media having oil thereon, comprising the steps of:
using a wetting roller to apply a low carbon alcohol to the printed media;
enabling the low carbon alcohol to mix with the oil on the printed media;
using a wiping roller to wipe the printed media; and
removing low carbon alcohol and oil from the printed media;
minimizing a fold crease area of the printed media.

15. (canceled)

16. (canceled)

17. The method according to claim 14, wherein the low carbon alcohol is selected from the group consisting of isopropanol, 1-butanol, 2-butanols, hexyl alcohol, and 1-octanol.

18. The method according to claim 14, wherein the printed media is produced by a continuous-web direct-to-paper printing process.
